(19) United States
(12) Patent Application Publication
(10) Pub. No.: US 2014/0365305 A1
(43) Pub. Date: Dec. 11, 2014

(54) PROVIDING GEOSPATIAL-TEMPORAL NEXT-BEST-ACTION DECISIONS

(71) Applicant: International Business Machines Corporation, Armonk, NY (US)

(72) Inventors: Yoel Arditi, Haifa (IS); Norbert Herman, Denver, CO (US); Daniel T. Lambert, New York, NY (US)

(21) Appl. No.: 13/913,634

(22) Filed: Jun. 10, 2013

(51) Int. Cl. G06Q 30/02

(52) U.S. Cl. CPC G06Q 30/0269; G06Q 30/0261
USPC 705/14.58

(57) ABSTRACT

Embodiments herein provide geospatial-temporal next-best-action decisions. Specifically, a predictive modeling tool is configured to receive, from a user, a first instance of unstructured data, the unstructured data containing an indicator of a transacting opportunity, and generate a profile for the user by combining the unstructured data with structured data, the profile including personality characteristics and identifying information of the user. The profile is used to identify the user as a producer of a second instance of unstructured data by comparing the personality characteristics and identifying information of the user to the second instance of unstructured data. A commercial offer is then generated based on information from the profile of the user and at least one of the first instance of unstructured data or the second instance of unstructured data, and the offer is communicated to the user when the user is located within a predetermined proximity to a retailer.

The following disclosure is submitted under 35 U.S.C. 102(b)(1)(A): DISCLOSURE: Sample of Top Products & Sample Companies, disclosed by Daniel T. Lambert and Norbert Herman on Aug. 31, 2012, page 1.

### FIELD OF THE INVENTION

The present invention relates generally to multi-channel marketing and, more specifically, to automated entity resolution and geospatial-temporal next-best-action marketing.

### BACKGROUND OF THE INVENTION

By some estimates, 80% of a company's useful customer information is stored in unstructured data. This includes blogs, e-mails, forum posts, social media, and, increasingly, transcripts of phone calls. Each touch point with the customer results in potentially useful information about transacting behaviors, lifestyles, interests, and the like. However, companies have not found a way to adequately capture this information and turn the data into useful action items.

There are a number of current art solutions that act as data aggregators or filters. These solutions are effective at enabling many representatives to contact customers, and generally monitor brand awareness. However, these solutions fall short in their ability to recognize and report the next best action to take with the customer.

With existing solutions, the content of the message is usually drafted by a customer service representative or the like. As such, there is no known way to automatically capture the attitudes and sentiment of the consumer towards various products. This is especially problematic at scale. First, companies with millions of customers cannot manually read every e-mail, social media post, etc. Second, humans may not be able to recognize less obvious, sentiments, shopping patterns, tendencies, etc. Humans may fail to notice many buyer pattern correlations because they are often nonsensical or not apparent unless statistically derived.

Furthermore, many businesses lack the ability to target the right customer at the right time and with the right message and context (location and time based). This has been a longstanding problem in marketing organizations. Certain companies have been making attempts to combine disparate data into consortium based models that collect and analyze pooled data from banks, retailers, and the like. For example, credit card companies have been known to link a user's credit account to the social media account of the user, wherein the user's social media handle (i.e., name or chosen identifier) is manually tied to the credit card. However, there is no social media discovery or entity resolution until the user ties the data together manually. If the manual entity resolution is not performed, the credit card company cannot identify that customer's other social media accounts, forum postings, or the like. Therefore, what is needed is at least one solution to the deficiencies of the prior art.

### SUMMARY OF THE INVENTION

In general, embodiments herein provide geospatial-temporal next-best-action decisions. Specifically, a predictive modeling tool is configured to receive, from a user, a first instance of unstructured data, the unstructured data containing an indicator of a transacting opportunity, and generate a profile for the user by combining the unstructured data with structured data, the profile including personality characteristics and identifying information of the user. The profile is used to identify the user as a producer of a second instance of unstructured data by comparing the personality characteristics and identifying information of the user to the second instance of unstructured data. A commercial offer is then generated based on information from the profile of the user and at least one of the first instance of unstructured data or the second instance of unstructured data, and the offer is communicated to the user when the user is located within a predetermined proximity to a retailer.

In one embodiment, there is a method for providing geospatial-temporal next-best-action decisions. In this embodiment, the method comprises the computer-implemented steps of: receiving, from a user, a first instance of unstructured data, the unstructured data containing an indicator of a transacting opportunity; generating a profile for the user by combining the unstructured social data with structured data, the profile comprising personality characteristics of the user and identifying information of the user; identifying the user as a producer of a second instance of unstructured data by comparing the personality characteristics of the user and the identifying information of the user to the second instance of unstructured data; generating a commercial offer based on the profile of the user and at least one of: the first instance of unstructured data, and the second instance of unstructured data; and initiating to communicate the commercial offer to the user when the user is located within a predetermined proximity to a retailer.

In another embodiment, there is a system for providing geospatial-temporal next-best-action decisions. In this embodiment, the system comprises at least one processing unit, and memory operably associated with the at least one processing unit. A predictive modeling tool is storable in memory and executable by the at least one processing unit. The predictive modeling tool comprises an analyzing component configured to receive, from a user, a first instance of unstructured data, the unstructured data containing an indicator of a transacting opportunity; a resolution component configured to: generate a profile for the user by combining the unstructured social data with structured data, the profile including personality characteristics of the user and identifying information of the user; and identify the user as a producer of a second instance of unstructured data by comparing the personality characteristics of the user and the identifying information of the user to the second instance of unstructured data; and an offering component configured to: generate a commercial offer based on the profile of the user and at least one of: the first instance of unstructured data, and the second instance of unstructured data; and initiate to communicate the commercial offer to the user when the user is located within a predetermined proximity to a retailer.

In another embodiment, there is a computer-readable storage medium storing computer instructions, which when executed, enables a computer system to provide geospatial-temporal next-best-action decisions. In this embodiment, the computer instructions comprise: receiving, from a user, a first instance of unstructured data, the unstructured data containing an indicator of a transacting opportunity; generating a profile for the user by combining the unstructured social data with structured data, the profile comprising personality characteristics of the user and identifying information of the user; identifying the user as a producer of a second instance of unstructured data by comparing the personality characteristics of the user and the identifying information of the user to the second instance of unstructured data; generating a commercial offer based on the profile of the user and at least one of: the first instance of unstructured data, and the second instance of unstructured data; and initiating to communicate the commercial offer to the user when the user is located within a predetermined proximity to a retailer.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a schematic of an exemplary computing environment in which elements of the present embodiments may operate;

FIG. 2 shows a more detailed view of a predictive modeling tool according to embodiments of the invention;

FIG. 3 shows an exemplary implementation of the predictive modeling tool according to embodiments of the invention; and

FIG. 4 shows a flow diagram for providing geospatial-temporal next-best-action decisions according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The invention will now be described more fully herein with reference to the accompanying drawings, in which exemplary embodiments are shown. Embodiments of the invention provide geospatial-temporal next-best-action decisions. Specifically, a predictive modeling tool is configured to receive, from a user, a first instance of unstructured data, the unstructured data containing an indicator of a transacting opportunity, and generate a profile for the user by combining the unstructured data with structured data, the profile including personality characteristics and identifying information of the user. The profile is used to identify the user as a producer of a second instance of unstructured data by comparing the personality characteristics and identifying information of the user to the second instance of unstructured data. A commercial offer is then generated based on information from the profile of the user and at least one of the first instance of unstructured data or the second instance of unstructured data, and the offer is communicated to the user when the user is located within a predetermined proximity to a retailer.

This disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “computing,” “determining,” “evaluating,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

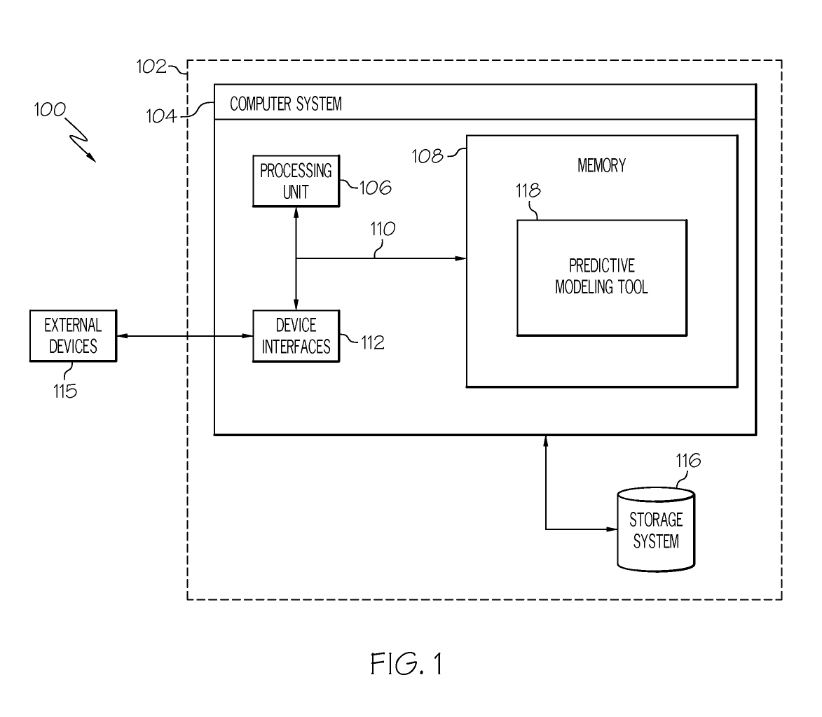

Referring now to FIG. 1, a computerized implementation 100 of the present invention will be described in greater detail. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), a cloud-computing environment, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for providing geospatial-temporal next-best-action decisions. It should be understood that any other computers implemented under the present invention may have different components/software, but will perform similar functions. As shown, computer system 104 includes a processing unit 106 capable of communicating with a next-best-action (NBA) tool 118 stored in memory 108, a bus 110, and device interfaces 112.

Processing unit 106 refers, generally, to any apparatus that performs logic operations, computational tasks, control functions, etc. A processor may include one more subsystems, components, and/or other processors. A processor will typically include various logic components that operate using a clock signal to latch data, advance logic states, synchronize computations and logic operations, and/or provide other timing functions. During operation, processing unit 106 collects and routes signals representing inputs and outputs between external devices 115 and predictive modeling tool 118. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating predictive modeling tool 118, which is stored in memory 108 and/or storage system 116. While executing computer program code, processing unit 106 can read and/or write data to/from memory 108, storage system 116, and predictive modeling tool 118. Storage system 116 can include VCRs, DVRs, RAID arrays, USB hard drives, optical disk recorders, flash storage devices, and/or any other data processing and storage elements for storing and/or processing data. Although not shown, computer system 104 could also include I/O interfaces that communicate with one or more external devices 115 (e.g., a cellular phone, a smart phone, a keyboard, a pointing device, a display, etc.) that enable interaction with computer system 104.

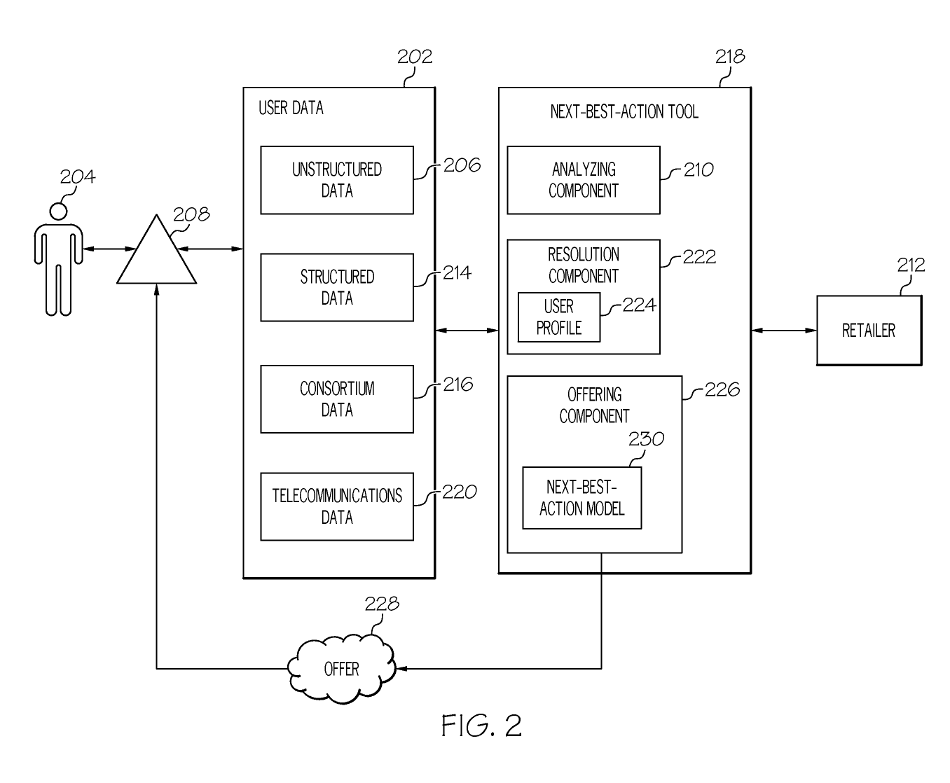

Referring now to FIG. 2, operation of predictive modeling tool 218 will be described in greater detail. As shown, FIG. 2 is a block diagram illustrating an example of a combination of processing components that can be used for implementing predictive modeling tool 118 in implementation 100 illustrated in FIG. 1. Predictive modeling tool 218 receives, aggregates, and analyzes user data 202 from a plurality of sources/channels to generate a commercial offer for a user 204. In an exemplary embodiment, unstructured social data 206 is received from user 204 (e.g., customers or potential customers) via a social media application 208. To accomplish this, predictive modeling tool 218 comprises an analyzing component 210 configured to receive a first instance of unstructured social data 206 from user 204, wherein the first instance of unstructured social data 206 comprises one or more indicators from an action within social media application 126 (e.g., Twitter®, Facebook®, LinkedIn®, etc.) that reveal sentiment (e.g., towards a particular product or company), personality traits of user 204, emotion state of user 204, etc. (Twitter is a registered trademark of Twitter, Inc. having an address at 1355 Market Street, Suite 900 San Francisco, Calif. 94103, Facebook is a registered trademark of Facebook, Inc. having an address at 1601 Willow Road Menlo Park, Calif. 94025, and LinkedIn is a registered trademark of LinkedIn Corporation having an address at Stierlin Court Mountain View, Calif. 94043.) The indicators from an action within social media application may be written text from a posting (i.e., a message sent to a social media application), a Facebook® or LinkedIn® “like”, etc., and represent a transacting opportunity for user 204, a selling opportunity for a retailer 212, or a customer satisfaction issue.

In one embodiment, analyzing component 210 is also configured to receive structured data 214 (e.g., a history of past transactions), consortium data 216 (e.g., shared anonymized data pooled from banking institutions, retailers, etc.), and telecommunications (telco) data 220 (e.g., network/wireless/wireline usage by the user). The combination of unstructured social data 206, structured data 214, consortium data 216, and telco data 220 can provide even deeper insight into what the next-best-action can be with user 204 or a group of users. To accomplish this, predictive modeling tool 218 comprises a resolution component 222 configured to combine one or more sources of user data 202 to generate a profile 224 for user 204, wherein profile 224 includes personality characteristics of user 204 and identifying information of user 204 for recognizing user 204 as a same entity across a plurality of data sources. In one embodiment, resolution component 140 receives consortium data 134 and/or telco data 220 from user 204, and generates user profile 224 based on the combination of unstructured social data 206, structured data 214, consortium data 216 and/or telco data 220. User profile 224 contains user sentiment (e.g., towards a particular product or company), personality traits of user 204, emotion state of user 204, etc., as well as data obtained from a number of disparate sources/accounts of user 204. For example, user profile 224 may contain the home address of user 204 discovered through a telco call record. Resolution component 222 is then able to use the information of user profile 224 to recognize user 204 as the same entity across a plurality of sources. Specifically, profile 224 is used to identify user 204 as a producer of a second instance of unstructured data 206 by comparing the personality characteristics and identifying information of user 204 to the second instance of unstructured data.

Furthermore, in some embodiments, linguistic style or probability of event occurrence may also be used to identify user 204. For example, user 204 may communicate the same specific event (e.g., “I'm watching a hockey game with my daughter, Avery.”) via Facebook® and Twitter®. In another example, similar connections and/or messages between users across both Facebook® and Twitter® may be leveraged to identify user 204. Resolving user 204 into a single entity enables discovery of additional unstructured data without explicitly tying the social media account to a structured account of user 204.

As shown in FIG. 2, predictive modeling tool 218 further comprises an offering component 226 configured to generate a commercial offer 228 based on user profile 224 and at least one of the first instance and the second instance of unstructured data 206. In one embodiment, a next-best-action (NBA) model 230 is used to accomplish this. NBA model 230 is a marketing and advertising model that provides next-best-action decision-making, wherein NBA model 230 considers the different actions that can be taken for user 204 and decides on the ‘best’ one. The NBA (e.g., an offer, proposition, service, etc.) is determined by the attributes (e.g., personality characteristics and identifying information) of user 204 within user profile 142, as well as a marketing organization's business objectives, policies, and regulations on the offer. NBA model 230 reliably achieves NBA capabilities in high volumes as well as in real-time. In one embodiment, this requires some form of decisioning hub that leverages decision logic to combine an advertisers business rules with predictive and adaptive decisioning models to help determine how to target and solicit user 204. The decisioning authority takes into account each user's expectations, propensities and likely behavior through the use of predictive modeling. The result is one or more commercial offers 228 generated for user 204 or selected from a predetermined selection of commercial offers. If feedback is received from user 204 in response to the commercial offering(s) 228, offering component 226 is configured to re-evaluate the offer 228 based on the response.

Offering component 226 is configured to then communicate commercial offer 228 to user 204 when user 204 is located within a predetermined proximity (e.g., 2 miles) to a retailer 212, wherein retailer 212 is identified as being capable of fulfilling the commercial offer to user 204. In one embodiment, commercial offer 228 is communicated to user 204 via at least one of: a message generated within social media application 208, a short message-system (SMS) text to a cell phone or smart phone (not shown) of user 204, or an electronic message (e-mail) to the cell phone or smart phone of user 204. Furthermore, commercial offer 228 is preferable communicated to user 204 soon after it's generated.

Offering component 226 also considers time and/or location to make sure the offer is delivered at the right time and place for maximum effectiveness. To accomplish this, analyzing component 210 is configured to receive temporal data for the indicator of the transacting opportunity (e.g., time of posting by user 204), as well as spatio temporal data for user 204 (e.g., time and location of user 204 at the time of the posting). Commercial offer 228 is then generated by offering component 226 based on the temporal data for the indicator of the transacting opportunity and the spatio-temporal data for user 204. In one embodiment, the home address of user 204 may match attributes of a Facebook®, LinkedIn®, or Twitter® profile, which contains location information, e.g., approximated through IP addresses, cookie history, etc. Offering component 226 may then determine that user 204 is located within a predetermined proximity to retailer 212 at the time of a social media posting and, therefore, identify a promotion being offered by retailer 212.

Location detection could be done through real time location information transmission, or through a predictive model based on historical telco data 220. For example, if user 204 frequently visits the same coffee shop on Saturdays at 10 AM, the predictive model knows the user's home location is 10 miles away, the predictive model can predict, with a certain degree of certainty, that user 204 will pass certain shops in between the two locations between 9:45 and 10:00 AM. If a shoe store is within the path of user 204, and unstructured social data 120 previously received contains an indicator representing a desire for new shoes, user 204 will receive an offer for shoes.

In another example, a browsing history from telco data 220 would enable a deeper analysis of unstructured social data 120. Consider an example in which user 204 is located inside an electronics store. Telco data 220 indicates that user 204 has previously searched a number of electronics websites, while a prior transaction record from structured data 214 indicates that user 204 purchased a TV five years ago. Based on this, user 204 could receive a targeted real time offer meant to entice user 204 into purchasing an item (e.g., a new TV) from the electronics store. Or, user 204 could receive a targeted real time offer that provides a better price/deal, e.g., from a competing electronics retailer to dissuade user 204 from making the purchase. This is an example of resolving user 204 across different dimensions, which then results in the next best action decision.

In yet another embodiment, a placed call, text message, or other action requiring interaction with a cellular tower could identify the right timing of offer 228. For example, a cell phone event inside a grocery store may trigger a time-based promotion for bread or cereal. A deep integration with cellular data, transacting history, and what user 204 has been talking about online enables a highly targeted offer with increased granularity.

It will be appreciated that offer 228 is communicated according to a set of communication permission settings established by user 204. Offering component 226 is configured to receive and manage these customer communication permission settings in real time, including across all instances of user 204, and support real time validation of the communication permission settings before any interaction with user 204 is executed. As such, user 204 is not inundated with unwanted offers from retailers (i.e., SPAM).

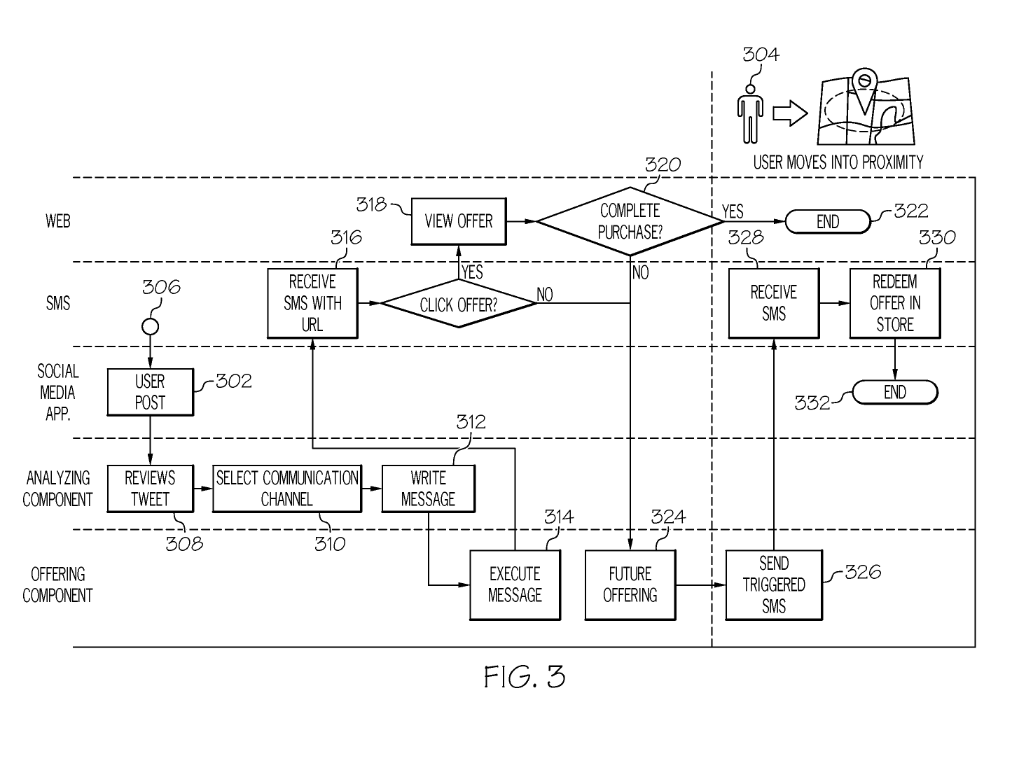

Referring now to FIG. 3, an implementation of predictive modeling tool 218 from FIG. 2 will be shown and described. In this non-limiting example, user 304 posts a tweet (302), e.g., about needing shoes, wherein the tweet may originate as an SMS message (306). The analyzing component reviews the tweet to identify a transacting opportunity (308), selects a communication channel (i.e., method and mode) (310), and writes the message of the offer (312). The offering component then generates the commercial offer (314), and sends the commercial offer to user 204 as an SMS containing a uniform resource locator (URL) (316). User 204 may click the URL to view the offer (318), e.g., in a web browser. If user 204 accepts the offer and completes the purchase (320), then the process ends (322). However, if user 204 does not click the offer or complete the purchase, then user 204 is queued up for a future offering (324). That is, if user 204 later moves into range of a shoe store, the offer will be re-triggered (326), sent to user 204 (328), which can then be redeemed in the shoe store (330), and the process ends (332).

As described herein, the present invention provides a tool, which reviews e-mails, blog entries, forum posts, social media postings, etc., and combines this data with structured data, telco data, consortium data, and spatio-temporal data to generate a next-best-action decision. In this case, predictive modeling tool 218 can be provided, and one or more systems for performing the processes described in the invention can be obtained and deployed to computer infrastructure 102 (FIG. 1). In one embodiment, predictive modeling tool 218 can be built from the following components:

Data services layer on top of a database with the in memory option (e.g. DB2). The in memory option enables predictive modeling tool 218 with real time capabilities;

Software Part Semantics Specification (SPSS) model execution engine; and/or

iLOG Business Rule Management System model execution engine;

A workflow engine that invokes the calculation of predictive values any time the predictor Key Performance Indicators (KPI) change;

A consumer behavior pattern detection store capturing and refining business rules for NBA execution;

Business Glossary to explain the meaning of the predictive values and the KPIs used; and

Telecom Operations Model (eTOM) based and Tivoli Data Warehouse (TDW) aligned customer model.

This framework of predictive modeling tool 218 uses G2 entity analytics to create a single identity by identifying the probabilities that a user is the same person across multiple channels and sources. This framework separates capture of data in real time from modeling done offline and execution based on a received real time event and activation of the analytics model created by modeling. In one embodiment, once a user has crossed a certain threshold probability, the entity may be considered ‘resolved’ until another discordant event puts that resolution into question.

The deployment of predictive modeling tool 218 can comprise one or more of: (1) installing program code on a data center device, such as a computer system, from a computer-readable storage medium; (2) adding one or more data center devices to the infrastructure; and (3) incorporating and/or modifying one or more existing systems of the infrastructure to enable the infrastructure to perform the process actions of the invention.

The exemplary computer system 104 (FIG. 1) may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

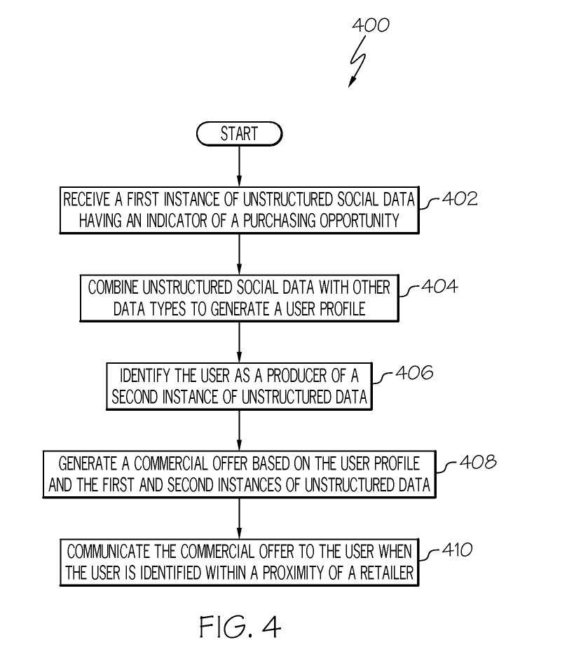

The program modules carry out the methodologies disclosed herein, as shown in FIG. 4. Shown is a process 400 for providing geospatial-temporal next-best-action decisions, wherein, at 402, a first instance of unstructured social data is received from a user, the unstructured data including an indicator of a transacting opportunity. At 404, the unstructured social data is combined with other data types (e.g., structured, consortium, telco, etc.) to generate a profile for the user. The profile is used, at 406, to identify the user as a producer of a second instance of unstructured data by comparing the personality characteristics and identifying information of the user to the second instance of unstructured data. At 408, a commercial offer is generated based on the profile of the user and at least one of the first instance and second instance of unstructured data. At 410, the commercial offer is initiated to communicate to the user when the user is located within a predetermined proximity to a retailer.

The flowchart of FIG. 4 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network.

Furthermore, as will be described herein, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations.

For example, an implementation of exemplary computer system 104 (FIG. 1) may be stored on or transmitted across some form of computer readable media. Computer readable media can be any available media that can be accessed by a computer. By way of example, and not limitation, computer readable media may comprise “computer storage media” and “communications media.”

“Computer-readable storage device” includes volatile and non-volatile, removable and non-removable computer storable media implemented in any method technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided an approach for providing geospatial-temporal next-best-action decisions. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for providing geospatial-temporal next-best-action decisions, the method comprising the computer-implemented steps of:
receiving, from a user, a first instance of unstructured data, the unstructured data containing an indicator of a transacting opportunity;
generating a profile for the user by combining the unstructured social data with structured data, the profile comprising personality characteristics of the user and identifying information of the user;
identifying the user as a producer of a second instance of unstructured data by comparing the personality characteristics of the user and the identifying information of the user to the second instance of unstructured data;
generating a commercial offer based on the profile of the user and at least one of: the first instance of unstructured data, and the second instance of unstructured data; and
initiating to communicate the commercial offer to the user when the user is located within a predetermined proximity to a retailer.

2. The method according to claim 1, wherein the indicator of a transacting opportunity comprises at least one of: sentiment of the user towards a product, personality traits of the user, and emotional state of the user.

3. The method according to claim 1, wherein the indicator of a transacting opportunity comprises one or more indicators generated from a message sent to a social media application.

4. The method according to claim 3, the communicating the commercial offer to the user comprising at least one of: generating a message within the social media application, sending a short-message-system (SMS) text, and sending an electronic message (e-mail) to a mobile device of the user.

5. The method according to claim 1, further comprising:
receiving temporal data corresponding to the indicator of the transacting opportunity; and
receiving spatio-temporal data corresponding to the user, wherein the commercial offer is generated based on information from the temporal data corresponding to the indicator of a transacting opportunity and the spatio-temporal data corresponding to the user.

6. The method according to claim 1, further comprising: receiving a shared pool of anonymized data, wherein the user profile is generated based on information from the unstructured data, the structured data, and the shared pool of anonymized data.

7. The method according to claim 6, further comprising: receiving telecommunications data corresponding to the user, wherein the user profile is generated based on information from the unstructured social data, the structured data, the shared pool of anonymized data, and the telecommunications data.

8. The method according to claim 1, further comprising: receiving a set of communication permission settings established by the user, wherein the commercial offer is communicated to the user according to the set of communication permission settings.

9. A computer system for providing geospatial-temporal next-best-action decisions, the system comprising:
at least one processing unit;
memory operably associated with the at least one processing unit; and
a predictive modeling tool storable in memory and executable by the at least one processing unit, the predictive modeling tool comprising:
an analyzing component configured to receive, from a user, a first instance of unstructured data, the unstructured data containing an indicator of a transacting opportunity;
a resolution component configured to:
generate a profile for the user by combining the unstructured social data with structured data, the profile including personality characteristics of the user and identifying information of the user; and
identify the user as a producer of a second instance of unstructured data by comparing the personality characteristics of the user and the identifying information of the user to the second instance of unstructured data; and
an offering component configured to:
generate a commercial offer based on the profile of the user and at least one of: the first instance of unstructured data, and the second instance of unstructured data; and
initiate to communicate the commercial offer to the user when the user is located within a predetermined proximity to a retailer.

10. The computer system according to claim 9, wherein the indicator of a transacting opportunity comprises one or more indicators generated from a message sent to a social media application, and wherein the indicator of the transacting opportunity comprises at least one of: sentiment of the user towards a product, personality traits of the user, and emotional state of the user.

11. The computer system according to claim 10, the offering component further configured to communicate the commercial offer according to a set of communication permission settings established by the user, wherein the commercial offer is communicated to the user via at least one of: a message generated within the social media application, a short-message-system (SMS) text, and an electronic message (e-mail) to a mobile device of the user.

12. The computer system according to claim 9, the analyzing component further configured to:
receive temporal data corresponding to the indicator of the transacting opportunity; and
receive spatio-temporal data corresponding to the user, wherein the commercial offer is generated based on information from the temporal data corresponding to the indicator of the transacting opportunity and the spatio-temporal data corresponding to the user.

13. The computer system according to claim 9, the resolution component further configured to receive a shared pool of anonymized data corresponding to the user, wherein the user profile is generated based on information from the unstructured social data, the structured data, and the shared pool of anonymized data.

14. The computer system according to claim 13, the resolution component further configured to receive telecommunications data corresponding to the user, wherein the user profile is generated based on information from the unstructured social data, the structured data, the shared pool of anonymized data, and the telecommunications data.

15. A computer-readable storage medium storing computer instructions, which when executed, enables a computer system to provide geospatial-temporal next-best-action decisions, the computer instructions comprising:
receiving, from a user, a first instance of unstructured data, the unstructured data containing an indicator of a transacting opportunity;
generating a profile for the user by combining the unstructured social data with structured data, the profile comprising personality characteristics of the user and identifying information of the user;
identifying the user as a producer of a second instance of unstructured data by comparing the personality characteristics of the user and the identifying information of the user to the second instance of unstructured data;
generating a commercial offer based on the profile of the user and at least one of: the first instance of unstructured data, and the second instance of unstructured data; and
initiating to communicate the commercial offer to the user when the user is located within a predetermined proximity to a retailer.

16. The computer-readable storage medium according to claim 15, wherein the indicator of a transacting opportunity comprises one or more indicators generated from a message sent to a social media application, and wherein the indicator of the transacting opportunity comprises at least one of: sentiment of the user towards a product, personality traits of the user, and emotional state of the user.

17. The computer-readable storage medium according to claim 16, the computer instructions for communicating further comprising communicating the commercial offer according to a set of communication permission settings established by the user, wherein the commercial offer is communicated to the user via at least one of: a message generated within the social media application, a short-message-system (SMS) text, and an electronic message (e-mail) to a mobile device of the user.

18. The computer-readable storage medium according to claim 15, the computer instructions further comprising:
receiving temporal data corresponding to the indicator of the transacting opportunity; and
receiving spatio-temporal data corresponding to the user, wherein the commercial offer is generated based on information from the temporal data corresponding to the indicator of the transacting opportunity and the spatio-temporal data corresponding to the user.

19. The computer-readable storage medium according to claim 15, the computer instructions further comprising receiving a shared pool of anonymized data corresponding to the user, wherein the profile is generated based on information from the unstructured social data, the structured data, and the shared pool of anonymized data.

20. The computer-readable storage medium according to claim 19, the computer instructions further comprising receiving telecommunications data corresponding to the user, wherein the user profile is generated based on information from the unstructured social data, the structured data, the shared pool of anonymized data, and the telecommunications data.
